(19) United States
(12) Patent Application Publication
(10) Pub. No.: US 2012/0052927 A1
(43) Pub. Date: Mar. 1, 2012

(54) SYSTEM AND METHOD FOR MANAGING MOBILE DEVICE POWER SUPPLY

(75) Inventors: HAO-CHUN CHEN, Tu-Cheng (TW); YAO-TUNG KUO, Tu-Cheng (TW); I-CHUN YANG, Tu-Cheng (TW); YAO-TING WU, Tu-Cheng (TW)

(73) Assignee: HON HAI PRECISION INDUSTRY CO., LTD., Tu-Cheng (TW)

(21) Appl. No.: 13/087,647

(22) Filed: Apr. 15, 2011

(30) Foreign Application Priority Data
Aug. 24, 2010 (CN) 201010261572.7

(51) Int. Cl. H04M 1/02

(52) U.S. Cl. 455/574

(57) ABSTRACT

A system for managing power supply of a mobile device, includes a random access memory, a storage device, and a battery. The random access memory will not store information therein without power. The storage device can store information therein regardless of power supplied to the storage device. The storage device is connected to the random access memory. The storage device includes an image area. The battery is connected to the random access memory and the storage device. The mobile device is configured to work between a normal mode and a first power-saving mode. In the normal mode, the battery supplies power to the random access memory. In the first power-saving mode, information stored in the random access memory is copied into the image area, and the battery stops providing power to the random access memory.

### BACKGROUND

1. Technical Field

The present disclosure relates to systems and methods for managing power supply, and particularly to a system and method for managing power supply for a mobile device.

2. Description of Related Art

With the rapid development of electronic technology, the traditional single-mode phones are gradually being replaced by dual-mode phones. A dual-mode phone is capable of selecting a compatible network amongst different communication networks to improve signal strength.

One of the problems of a dual-mode phone integrating a global system for mobile communications (GSM) sub-system with a wireless fidelity (WiFi) sub-system is that, the dual-mode phone communicates with a GSM-based station and a WiFi-based access point simultaneously every microsecond, and a power supply inside the dual-mode phone has to supply power thereto continuously, reducing a standby time thereof accordingly.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a system for managing mobile device power supply.

FIG. 2 is a flow chart of an embodiment of a method for managing mobile device power supply.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

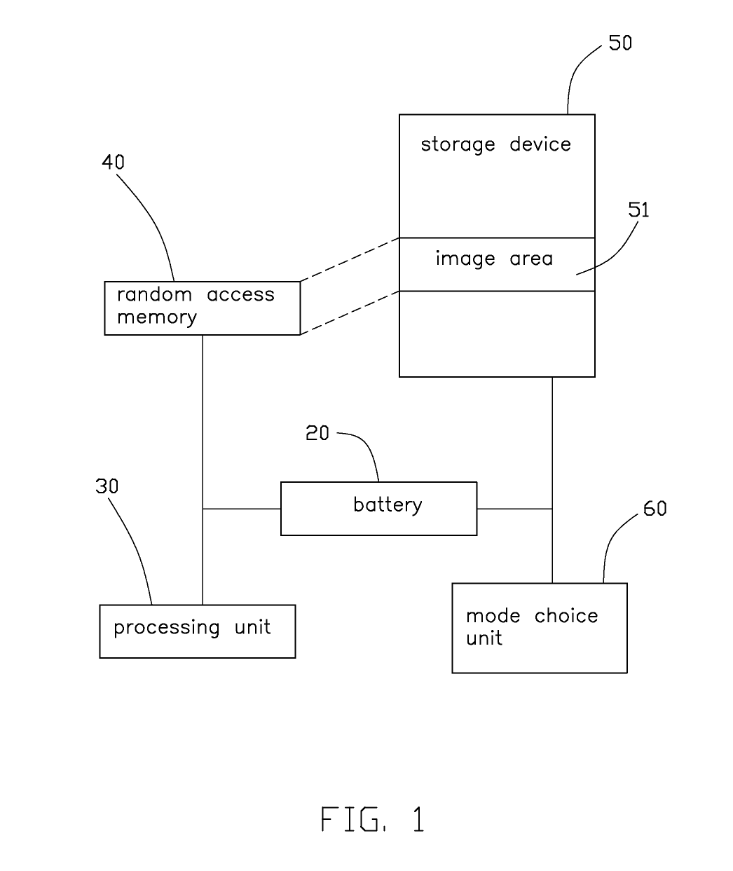

Referring to FIG. 1, a system, in accordance with an embodiment for managing power supply of a mobile device, includes a battery 20, a processing unit 30, a random access memory (RAM) 40, a storage device 50, and a mode choice unit 60. The battery 20 provides power to the processing unit 30, the RAM 40, the storage device 50, and the mode choice unit 60.

Information in the RAM can be stored only when the battery 20 provides power to the RAM. If the battery 20 does not provide power to the RAM 40, then information in the RAM 40 cannot be stored. On the other hand, information in the storage device 50 can be stored even if the battery 20 does not provide power to the storage device 50. The RAM 40 connects to the processing unit 30 and the storage device 50. Information stored in the storage device 50 can be transmitted to the RAM 40. The processing unit 30 can directly access and process the information that is stored in the RAM 40.

The storage device 50 can store music, books, and pictures therein for the mobile device. The storage device 50 also defines an image area 51, which corresponds to the RAM 40. Information stored in the RAM 40 can be copied to the image area 51, and stored in the image area 51 for backup.

The mode choice unit 60 is connected to the battery 20. Specifically, the mode choice unit 60 defines different running modes for the mobile device and correspondingly controls the battery 20 providing power in different manners. In one embodiment, the mode choice unit 60 defines three different running modes: normal mode, suspending to random access memory mode, and suspending to storage device mode.

In the normal mode, the battery 20 provides power to the processing unit 30, the random access memory 40, the storage device 50, and the mode choice unit 60.

In the suspending to random access memory mode, the battery 20 provides power to the random access memory 40 and the mode choice unit 60 and does not provide power to the processing unit 30 and the storage device 50. When the mobile device turns into the suspending to random access memory mode, the information processed by the processing unit 30 is stored in the random access memory 40. When the mobile device returns back to the normal mode from the suspending to random access memory mode, the processing unit 30 directly reads the information stored in the random access memory 40.

In the suspending to storage device mode, the battery 20 provides power to the mode choice unit 60 and does not provide power to the processing unit 30, the random access memory 40, or the storage device 50. When the mobile device turns into the suspending to storage device mode, the information processed by the processing unit 30 is stored in the random access memory 40 first, and then the information stored in the random access memory 40 is stored in the image area 51 of the storage device 50. When the mobile device returns back to the normal mode from the suspending to storage device mode, the information stored in the image area 51 is copied to the random access memory 40, and then processing unit 30 reads the information in the random access memory 40.

The mode choice unit 60 can switch between the mobile device running in the three running modes. For example, if the mode choice unit 60 detects the mobile device is being idle for a period of time, the mode choice unit 60 switches the mobile device to the suspending to storage device mode. If the mode choice unit 60 detects a key of the mobile device being triggered, the mode choice unit 60 switches the mobile device back to the normal mode.

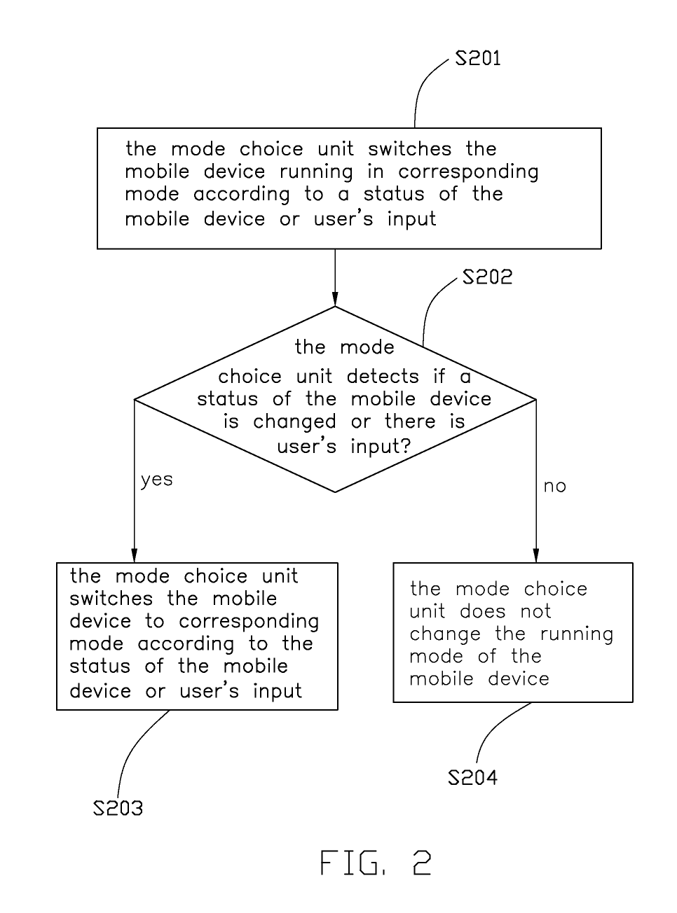

FIG. 2 is a flow chart illustrating a method for managing power supply of a mobile device. Depending on the embodiment, certain steps described below may be removed, while others may be added, and the sequence of the steps may be altered. In one embodiment, the method for power supply of a mobile device includes the following steps:

S201: the mode choice unit 60 switches the mobile device running in corresponding mode according to a status of the mobile device or user's input; then go to S202;

S202: the mode choice unit 60 detects if a status of the mobile device is changed or there is user's input; if yes, go to step S203; if not, go to S204;

S203: the mode choice unit 60 switches the mobile device to corresponding mode according to the status of the mobile device or user's input;

S204: the mode choice unit 60 does not change the running mode of the mobile device.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed. It is also to be understood that the above description and the claims drawn to a method may include some indication in reference to certain steps. However, the indication used is only to be viewed for identification purposes and not as a suggestion as to an order for the steps.

What is claimed is:

1. A system for managing power supply of a mobile device, comprising:
a random access memory that will not store information therein without power;
a storage device which can store information therein regardless of power supplied to the storage device, the storage device connected to the random access memory, and the storage device comprising an image area;
a battery connected to the random access memory and the storage device;
wherein the mobile device is configured to switch between a normal mode and a first power-saving mode; in the normal mode, the battery supplies power to the random access memory; and when switching to the first power-saving mode, the image area is configured to copy the information stored in the random access memory, and the battery is configured to stop providing power to the random access memory.

2. The system of claim 1, further comprising a processing unit, wherein the processing unit is configured to process the information stored in the random access memory when the mobile device works in the normal mode.

3. The system of claim 2, wherein the battery provides power to the processing unit when the mobile device works in the normal mode, and does not provide power to the processing unit when the mobile device works in the first power-saving mode.

4. The system of claim 2, wherein the mobile device further can work in a second power-saving mode; and in the second power-saving mode the battery supplies power to the random access memory, and does not supply power to the processing unit.

5. The system of claim 1, further comprising a mode choice unit, wherein the mode choice unit is connected to the battery, the mode choice unit is configured to receive control signals to control the battery providing power to the random access memory or not.

6. The system of claim 5, wherein the control signals comprises information of a status of the mobile device.

7. The system of claim 5, wherein the control signals comprises user's input.

8. A method for managing power supply of a mobile device, comprising:
providing power to a random access memory and a storage device by a battery, wherein the random access memory will not store information therein without power, and the storage device can store information therein regardless of power supplied to the storage device;
causing the mobile device to run in a first power saving mode by a mode choice unit when a first control signal is received by the mode choice unit;
copying information stored in the random access memory into an image area of the storage device; and
stopping providing power to the random access memory by the battery.

9. The method of claim 8, further comprising causing the mobile device to run in a normal mode, wherein causing the mobile device to run in the normal mode is completed after the mode choice unit causes the mobile device to run in the first power saving mode, and in the normal mode, the battery provides power to the random access memory, and the information in the image area is copied to the random access memory.

10. The method of claim 8, wherein the first control signal comprises information of a status of the mobile device.

11. The method of claim 8, wherein the first control signal comprises user's input.
